(19) United States
(12) Patent Application Publication
(10) Pub. No.: US 2002/0088778 A1
(43) Pub. Date: Jul. 11, 2002

(54) Apparatus and method for laser welding bellows based on reference point determining

(75) Inventor: Dale U. Chang, Windermere, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: LaserTech USA, LLC, Orlando, FL (US)

(21) Appl. No.: 10/091,012

(22) Filed: Mar. 5, 2002

Related U.S. Application Data
(63) Continuation-in-part of application No. 09/532,139, filed on Mar. 21, 2000.
Application No. 09/532,139 is a continuation-in-part of application No. 08/921,292, filed on Aug. 29, 1997, now Pat. No. 6,040,550.
(60) Provisional application No. 60/029,823, filed on Oct. 28, 1996.

(51) Int. Cl. B23K 26/28; B23K 26/03

(52) U.S. Cl. 219/121.63; 219/121.83; 219/121.64

(57) ABSTRACT

A laser welding apparatus includes a fixture for supporting a plurality of bellows diaphragms in side-by-side relation to define pairs of adjacent outer edges to be welded adjacent a laser. The apparatus also includes a reference point determining device for determining at least one reference point relating to locations of the outer edges. A positioner and controller are provided to position the laser relative to the fixture and to control the direction of the laser beam to weld edges based on the at least one reference point.

### RELATED APPLICATIONS

The present application is a continuation-in-part of U.S. patent application Ser. No. 09/532,139, filed Mar. 21, 2000, which, in turn, is a continuation-in-part application of U.S. Pat. No. 6,040,550 which, in turn, is based upon U.S. Provisional Patent Application Serial No. 60/029,823, filed on Oct. 28, 1996. The entire disclosure of each of which is incorporated herein by reference.

### FIELD OF THE INVENTION

The present invention relates to the field of precision manufacturing, and, more particularly, to an apparatus and method for forming metal bellows using laser welding.

### BACKGROUND OF THE INVENTION

Precision metal bellows are widely used in a number of applications where movement is required, but where sealing is also desired. For example, where it is desirable to have a vacuum on the exterior or interior of the bellows, the bellows provides environmental sealing. In other words, a bellows may be used as a boot for protective sealing. A bellows may also be used as a mechanical actuator by controlling pressure within the bellows, for example.

A bellows may be formed by joining together a series of bellows diaphragms in a predetermined pattern. A typical diaphragm is a generally circular disk with concentric folds formed therein. The diaphragms are joined together so that adjacent inside edges are connected together and adjacent outside edges are connected in an alternating fashion. The conventional approach to joining the diaphragms has been to tungsten inert gas (TIG) weld both the inside and outside joints. Unfortunately, TIG welding is relatively slow and may produce inconsistent quality welds.

In general, in TIG welding a pair of diaphragms are positioned in side-by-side relation and the interior weld is first formed using an inside diameter welding machine. Once a sufficient number of welded pairs or convolutions are made, these are assembled and positioned on a spindle or arbor. Copper “chill rings” or spacers are positioned between opposing outer portions. The chill rings help control the heating and heat dissipation of the diaphragms. The assembled convolutions and chill rings are rotated on the arbor, and each outer seam is TIG welded. The arc welding torch is indexed to each of the seams for welding. An operator watches the welding arc through a stereo microscope for alignment before and during welding. This operation may be very tedious for the operator. Moreover, the outcome of the bellows depends largely on the skills, experience, acuity, attentiveness, and the physical condition of the operator.

Once the outer welds are completed the structure is removed from the arbor, and the copper chill rings are then removed and discarded. Unfortunately, the copper chill rings must be made to relatively exacting tolerances and are therefore relatively expensive. Moreover, once used the copper rings are discarded, and new rings must be supplied and used for making the next bellows. Accordingly, the cost of manufacturing is increased because of the cost of the copper chill rings.

Precision metal bellows manufacturing has been relying on gas tungsten arc (GTAW) or TIG welding for metal bellows for the past 30 years. Many improvements have been made to the process including power control, pulsing techniques and torch configuration. Unfortunately, the conventional arc welding process has inherent limitations in terms of productivity and quality. The welding speed is relatively slow (10-20 inches per minute) and the weld quality degrades as the welding tip wears out.

Constant adjustments and finesse are needed to maintain the weld quality. In addition, the weld quality depends largely on the skill and the acuity of the operator. The process is labor intensive and is not well suited for automation. The costs of disposable and consumable items are also high.

U.S. Pat. No. 3,918,622 to Larsen discloses tungsten inert gas (TIG) welding of the outer joint of a plurality of stacked diaphragms and with optical tracking of a weld immediately following the formation thereof to maintain precise torch alignment with the weld joint. The diaphragms to be welded are stacked on a rotatable arbor. A radiation source such as a lamp, is focused by a lens and directed by a mirror to the seam. Reflected light from the seam is sensed by two side-by-side phototransducers so that a difference in the two output signals indicates the lateral displacement of the seam. Unfortunately, the split photosensor system described may not accurately indicate the position of the relatively small seams of many commercially desirable bellows.

Also relating to joining diaphragms to form a metal bellows, U.S. Pat. No. 3,626,582 to Melill discloses diffusion bonding for the stacked diaphragms. The fabrication requires pressuring fixture tooling including an external steel cylindrical retainer ring and an internal steel cylindrical retainer plug, together with a force transmitting annular ram and multiple thin steel pressure support rings using to transmit the bonding forces of the high pressure ram. The process, unfortunately, is relatively complicated and expensive at it requires elevated temperatures of 1600-1700 degrees F. at 500 PSI pressure for 5 hours for typical thin sheet metal titanium diaphragms.

Laser and electron beam apparatus have also been disclosed for welding the joints of metal bellows. For example, U.S. Pat. No. 4,760,236 to Stoll discloses a laser welding apparatus wherein the outer diameter welds are made one at a time to form pairs of diaphragms. The pair of diaphragms are pressed between opposing tooling fixture portions to ensure alignment. To form the inner welds, a series of pairs are positioned within an evacuated chamber and the laser beam is directed through the center opening to the inner weld positions. For both the inner and outer welds, the laser beam is directed at an oblique angle. Unfortunately, an oblique angle may cause a nonsymmetrical and low quality weld. Moreover, precise positioning of the laser beam for the inside welds may be difficult and result in poor quality welds.

U.S. Pat. Nos. 5,478,983 and 5,410,123 both to Rancourt disclose an apparatus for forming a bellows bladder using a laser beam to form the inner and outer welds. An oblong shaped laser spot is used for welding. In addition, a comb structure is used to separate and position interior joints and exterior joints for laser welding. Precise relative positioning requires high accuracy of the comb and little or no variations in the convolutions. In short, precise positioning of the laser beam relative to the weld areas may be difficult to achieve.

Parent patent, U.S. Pat. No. 6,040,550, discloses significant improvements in laser welding the outer joints of metal bellows. In some embodiments, continuous optical tracking of the bellows components on a rotating arbor is used during the laser welding. The embodiments, of course, produces very high quality bellows. For some applications, however, the continuous tracking may be relatively complicated to manufacture, operate and/or maintain.

### SUMMARY OF THE INVENTION

In view of the foregoing background, it is therefore an object of the present invention to provide an apparatus and method for laser welding the outer edges of bellows that may not require continuous seam tracking, for example.

This and other objects, features and advantages in accordance with the present invention are provided by apparatus comprising a fixture for supporting bellows components in side-by-side relation to define a plurality of pairs of adjacent outer edges to be welded together, and a reference point determining device for determining at least one reference point relating to locations of the pairs of adjacent outer edges. The apparatus may also include a laser for generating a laser beam and a positioner for relatively positioning the laser beam and the fixture. In addition, the apparatus may include a controller for controlling the laser and the positioner so that the laser beam welds together the pairs of adjacent outer edges based upon the at least one reference point. Accordingly, the relative complexity of continuous tracking system is not required, and the apparatus may still produce welds of sufficient quality.

In some embodiments, the one or more reference points are on the pairs of adjacent outer edges. For example, the at least one reference point may comprise a reference point on at least one of the pairs of adjacent outer edges of bellows components. If only one pair of edges is used to define the reference point, the locations of the other pairs of outer edges can be calculated based upon a known spacing, for example.

The at least one reference point may also comprise a respective reference point on each of the pairs of adjacent outer edges of the bellows components. In other words, reference points can be determined for all of the pairs of outer edges.

The at least one reference point may comprise a plurality of reference points for at least one of the pairs of adjacent outer edges. In this variation, the controller may determine an average reference point to be used for the relative positioning based upon the plurality of reference points.

Along these lines, the laser beam can be made to follow a predetermined function between successive reference points, the reference points being determined by the reference point determining device automatically or from input supplied by an operator. The specific function can be, for example, a linear function, a logarithmic function, a polynomial function, a power function, an exponential function, or a function based on a moving average. The particular function can be preselected or based on one or more reference points determined prior to or contemporaneously with laser welding.

Since a high precision fixture may be used, the reference point may be on the fixture. This may be in addition to, or in lieu of, one or more reference points on the pairs of adjacent outer edges. In other words, in some embodiments the at least one reference point is on the fixture.

The controller preferably operates the laser for welding after the reference point determining device determines the at least one reference point. In other words, the apparatus need not try to continuously optically track the outer edges while the laser is operating.

In accordance with one important aspect of the invention, the laser may provide an enlarged beam coverage area to weld the pairs of adjacent outer edges of bellows components. This enlarged beam coverage area can effectively weld the edges despite slight errors in relative positioning of the laser beam and the pairs of adjacent outer edges. In addition, more than one laser may be used, or, alternately, the laser beam of a single laser may be divided to simultaneously weld multiple pairs of adjacent outer edges to increase speed.

In one class of embodiments, the reference point determining device uses input from an operator. More particularly, the reference point determining device may include an optical system for presenting to the operator an image of at least one pair of adjacent edges of bellows components, and an input device for accepting from the operator an input to set the at least one reference point for use by the controller. For example, the optical system may present a magnified image of the at least one pair of adjacent edges of bellows components. The optical system may include a camera and a display connected thereto. In addition, the camera may be an infrared camera so that the operator can also recognize the relatively hotter edges after welding.

In another class of embodiments, the reference point determining device is more automated. For example, the reference point determining device may comprise a sensor connected to the controller. The sensor may be an optical sensor, proximity sensor, contacting sensor, etc.

The bellows components may comprise at least one end plate and/or a plurality of bellows diaphragms. In addition, the fixture may comprise a rotatable arbor and a drive motor connected thereto.

A method aspect of the invention is directed to laser welding adjacent outer edges of bellows components without the necessity of continuous seam tracking. The method may include supporting a plurality of bellows components on a fixture adjacent a laser in a side-by-side relation to define at least one pair of adjacent outer edges to be welded together. The method aspect may further include determining at least one reference point relating to locations of the at least one pair of adjacent outer edges of the bellows components, and directing a laser beam so that the laser beam welds together the at least one pair of adjacent outer edges based upon the at least one reference point.

Another method aspect of the invention is directed to laser welding adjacent outer edges of bellows components using at least one reference point determined on the basis of input supplied by an operator. The method can include supporting a plurality of bellows components on a fixture in side-by-side relation to define a plurality of pairs of adjacent outer edges to be welded together. The method also can include presenting to an operator an image of the at least one pair of adjacent edges, and accepting from the operator an input to set at least one reference point relating to locations of pairs of adjacent edges of bellows components supported on the fixture. The method can further include directing a laser beam so that the laser beam welds together the at least one pair of adjacent outer edges based on the at least one reference point.

### BRIEF DESCRIPTION OF THE DRAWINGS

FIG. 1 is a schematic block diagram of an apparatus for welding adjacent outer edges of bellows components to make bellows according to the present invention.

FIG. 2 is a more detailed schematic block diagram of the apparatus as shown in FIG. 1.

FIG. 3 is a side view of a rotating arbor of the apparatus shown in FIG. 2 along with a greatly enlarged portion of several adjacent outer edges and associated chill rings.

FIG. 4 is a schematic block diagram of another embodiment of the laser beam steering portion of the apparatus in accordance with the present invention.

FIGS. 5-10 are schematic diagrams of paths of the wobble of the seam between two adjacent outer edges and the actual position of the laser beam through a full rotation of the bellows for different embodiments of the invention.

FIG. 11 is a plot of a linear function fitted to a set of reference points in accordance with the invention.

FIG. 12 is a plot of a logarithmic curve fitted to a set of reference points in accordance with the invention.

FIG. 13 is a plot of a polynomial curve fitted to a set of reference points in accordance with the invention.

FIG. 14 is a plot of a power curve fitted to a set of reference points in accordance with the invention.

FIG. 15 is a plot of an exponential curve fitted to a set of reference points in accordance with the invention.

FIG. 16 is a plot of a curve derived from a moving average of a set of reference points in accordance with the invention.

FIGS. 17-19 are top plan views of a portion of several adjacent bellows components positioned on the arbor as shown in FIG. 3 illustrating various embodiments for the reference points.

FIG. 20 is a top plan view of a portion of the arbor as shown in FIG. 3 illustrating a reference point on the arbor.

FIG. 21 is a perspective view of the display as shown in FIG. 2.

FIGS. 22 and 23 are greatly enlarged top plan views of a portion of several adjacent bellows components on the arbor as shown in FIG. 3 illustrating variations of an enlarged laser beam coverage area.

FIG. 24 is a greatly enlarged top plan view of a portion of several adjacent bellows components on the arbor as shown in FIG. 3 illustrating simultaneous welding of multiple pairs of adjacent edges of bellows components.

### DETAILED DESCRIPTION OF THE PREFERRED EMBODIMENTS

The present invention will now be described more fully hereinafter with reference to the accompanying drawings in which preferred embodiments of the invention are shown. This invention, however, may be embodied in many different forms and should not be construed as limited to the embodiments set forth herein. Rather, these embodiments are provided so that this disclosure will thoroughly and completely convey the scope of the invention to those skilled in the art. Like numbers refer to like elements throughout.

As used herein, the term bellows component includes a diaphragm, such as a thin-gauge stamping in the form of an annulus (with or without formed bends) that when joined with another such diaphragm forms a convolution. The term bellows component is also intended to include a flange or end plate that can be welded to a diaphragm. As will be readily appreciated by one skilled in the art, a bellows ordinarily comprises one or segments of convolutions formed from joined diaphragms along with one or more flanges or end plates.

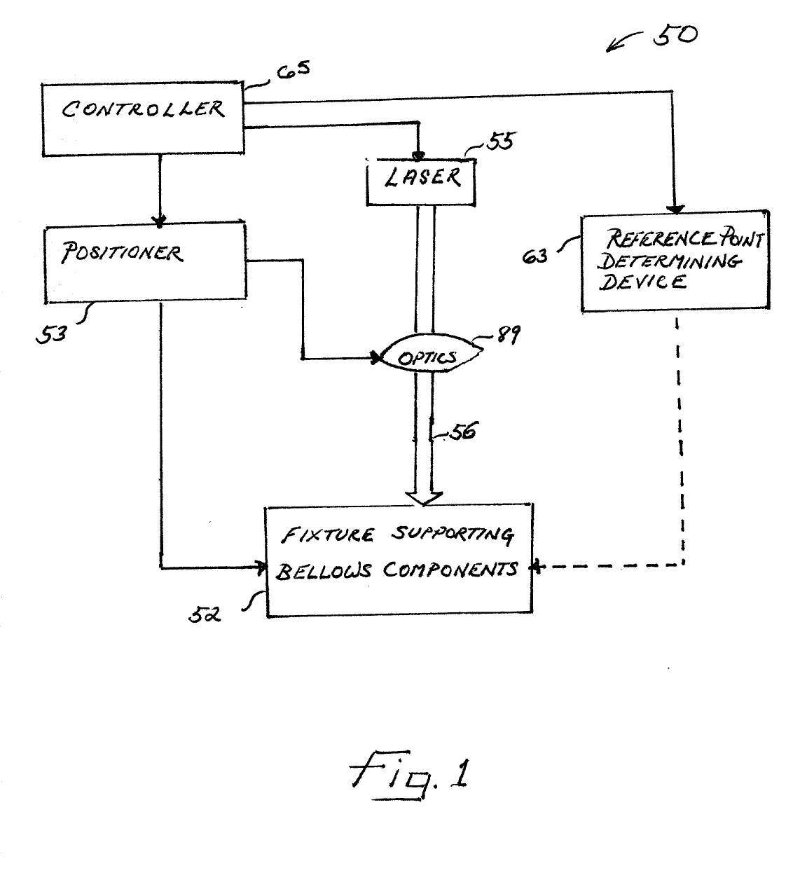

Referring initially to FIG. 1, an apparatus 50 for making bellows from bellows components according to the present invention is described. The apparatus 50 includes a laser 55 for generating a laser beam 56 to weld adjacent outer edges of bellows components. In addition, the apparatus includes a fixture 52 for supporting a plurality of bellows components in relation to the laser 55. The apparatus 50 also includes a positioner 53 for positioning, relative to one another, the laser beam 56 generated by the laser 55 and the fixture 52.

The positioner 53 may position one or both of the fixture 52 or laser beam 56. The laser beam may be directed by the schematically illustrated optics 89.

The apparatus 50 further includes a reference point determining device 63 for determining at least one reference point relating to locations of pairs of adjacent outer edges of the bellows components supported on the fixture 52. The apparatus 50 also illustratively includes a controller 65 for controlling the laser 55 and the positioner 53 so that the laser beam 56 generated by the laser welds together the pairs of adjacent outer edges based upon the at least one reference point determined by the reference point determining device 63.

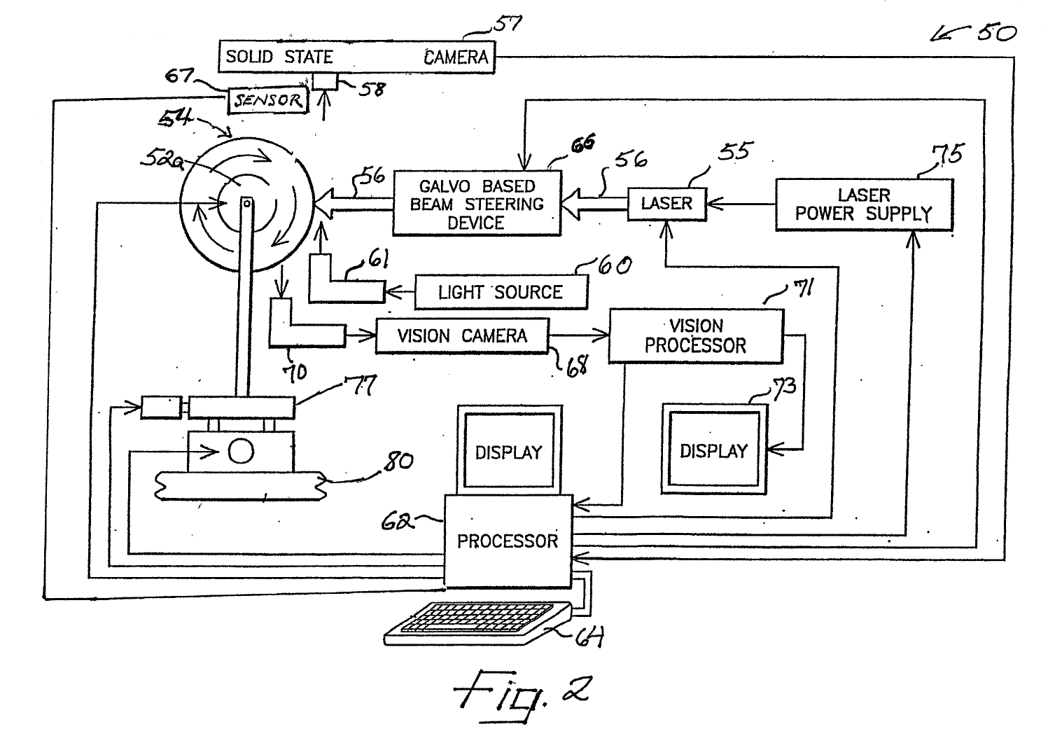

Referring now additionally to FIGS. 2 and 3, an embodiment of the apparatus 50 is described in further detail. The fixture 52 is provided by an arbor 52a that can be rotated using a light-weight lathe motor to thereby rotate bellows components 54 arranged thereon in relation to the laser beam 56. As will be readily apparent to those skilled in the art, however, other types of fixtures, both fully and partially rotatable, as well as non-rotable ones, may be used to support a plurality of bellows components 54 and to move the bellows components in relation to the laser beam 56 to weld together the bellows components.

As shown perhaps best in FIG. 3, the bellows components 54, including both diaphragms and end plates, can be arranged on the arbor 52a in pairs of opposing first and second components, each pair defining a pair of adjacent outer edges 54a, 54b of bellows components 54. As also shown, chill rings or spacers 59 may be positioned between adjacent pairs of diaphragms. The chill rings 59 provide for clamping of adjacent diaphragms and for the separation of molten metal from unwanted bridging to the adjacent diaphragms. The chill rings 59 may be copper and its alloys, or stainless steel as used in conventional TIG welding as will be readily appreciated by those skilled in the art. Alternately, though, the chill rings 59 may be of a reusable plastic material.

In this stacked arrangement upon the arbor 52a, the pairs of adjacent outer edges 54a, 54b of bellows components 54 can be welded together diaphragm to diaphragm and/or diaphragm to end plate and/or flange. Moreover, as will be readily understood by those skilled in the art, several distinct bellows assemblies can be welded at one loading by skipping welding of intermediate seams between adjacent outer edges of the bellows components 54.

The reference point determining device 63 can include a camera 57 in communication with a processor 62. The camera 57, for example, can be a solid-state camera that captures an image of rotating outer joints formed by pairs of adjacent outer edges 54a, 54b of bellows components 54 as they rotate on the fixture. The solid-state camera, moreover, can be of a line scan or area scan type. In addition, as illustrated, a magnifying lens 58 can be associated with the camera 57.

As a complement to or in lieu of the camera 57, the reference point determining device 63 can also include any of a variety of sensors. The sensor 67, specifically, may be an optical sensor, proximity sensor, or contacting sensor.

The reference point determining device 63 can include an illumination source that as shown comprises a light source 60 and associated optics 61. The illumination source can direct light onto at least one pair of adjacent outer edges 54a, 54b so as to contrast the darker region of the seam S between adjacent outer edges 54a, 54b of the bellows components 54. Alternately, the light source 60 can be positioned relative to the arbor 52a and the camera 57 so as to back light the bellows components 54 supported on the arbor.

The contrast between a seam S and a pair of adjacent outer edges 54a, 54b created by reflected or emanated light can be captured by the camera 57 as the bellows components 54 rotate on the arbor 52a. As will be readily appreciated by those skilled in the art, the camera 57 is capable of forming an image (e.g., on a linear pixel array) corresponding to the area encompassing the adjacent outer edges 54a, 54b, which, in turn, can be transformed by the processor 62 into an output signal (e.g., voltage differential or digital data stream) that indicates the location of points on the outer edges adjacent the seam S.

The position of a seam S and/or a corresponding pair of adjacent outer edges 54a, 54b can likewise be determined by the sensor 67. The sensor 67 may operate in response to an optical, contact, proximity, or other stimulus as will be readily understood by those skilled in the art.

Accordingly, the camera 57 and/or sensor 67 provides a digital or analog signal indicating reference points of the seam or corresponding edges of adjacent outer edges 54a, 54b of the bellows components 54. As will be further understood by those skilled in the art, digital data or subsequently digitized analog data so acquired can be stored in a memory prior to welding or, alternately, generated and used in real-time concurrently with an on-going welding process.

The positioner 53 illustratively includes a beam steering mechanism, such as a galvanometer-based mechanism 66. Alternately or in addition thereto, the beam steering mechanism can include an associated optical element, such as a mirror or prism connected to a galvanometer as well as a focusing lens as would be readily understood by those skilled in the art. As will be further understood by those skilled in the art, a number of different lenses having differing diameters and focal lengths can be utilized. Still further, as also will be understood by those skilled in the art, a reflector such as an off-axis parabolic mirror can be used in lieu of a lens.

The positioner can further include the illustrated X-Y table 77 for rapid and efficient movement of the arbor 52a. The X-Y table 77, moreover, can be mounted to a frame 80 that also carries the other components of the apparatus 50.

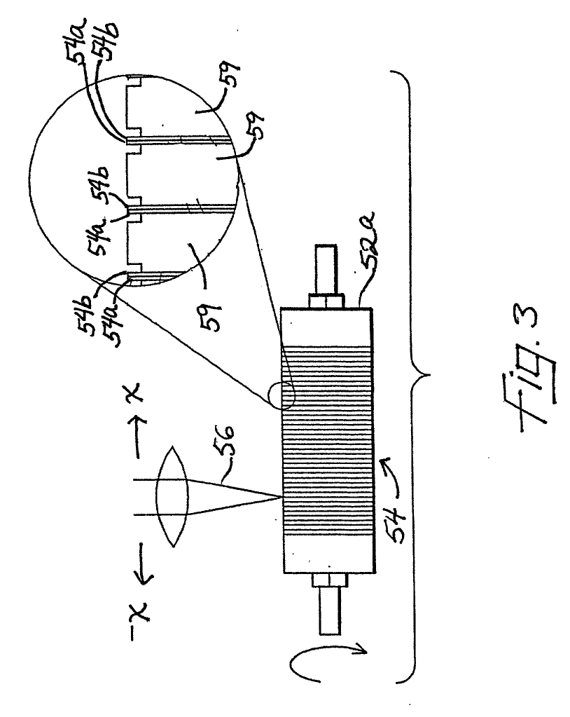

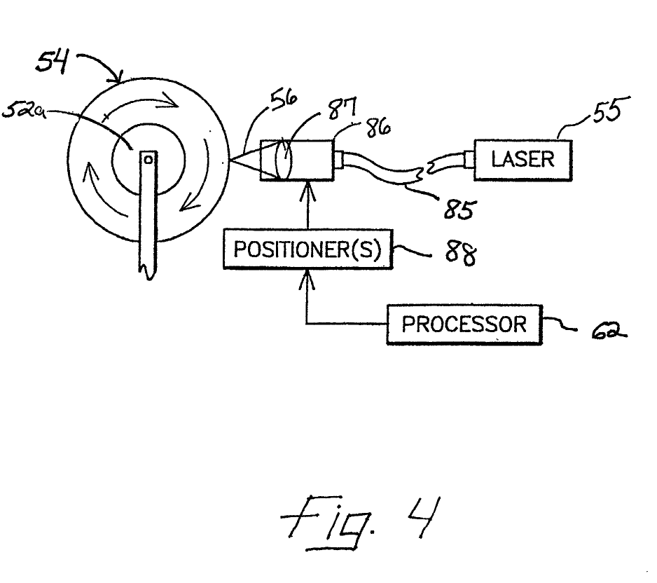

An alternate embodiment, of the positioner is illustrated in FIG. 4, in which the laser beam 56 is directed using an optical fiber cable 85 connected between the laser 55 and a positionable head 86. The head, in turn, may carry a lens 87 for focusing the laser beam 56 to the arbor 52a. The head 86 is positionable along one or more directions by the illustrated positioner 88 of a conventional type.

The controller 65 receives data from the reference point determining device 63, and, based on the data, the controller controls the laser 55 and positioner 53 to direct the laser beam to impinge the bellows components 54 so that the pairs of adjacent outer edges 54a, 54b are welded based on the at least one reference point as explained in more detail below. More specifically, the controller 65 can receive in real-time or from a memory associated therewith the data based on an image or sensed signal corresponding to portions of the adjacent outer edges 54a, 54b of the bellows components 54 to be welded to one another. By comparing the position of the laser beam 56 and the fixture 52a relative to each other, the controller 65 can direct movement of the fixture and movement of the laser beam 56.

When mapped as a plot of points on a planar surface, the seam S between the outer edges 54a, 54b of a pair of bellows components 54 is likely to “wobble” relative to a centered reference point as the seam S advances with the rotation of the bellows components on the fixture 52a. For the sake of convenience and clarity, it is useful to plot the seam S and/or edges on a Cartesian plane in which the forward advance of the seam S and/or edges due to rotation on the fixture is plotted on the Y-axis. Correspondingly, changes in position of the seam S and/or edges lateral to the advance are plotted on the X-axis. Examples of how the seams S and/or adjacent outer edges may wobble as the bellows components are rotationally advanced on the fixture are shown in FIGS. 5-10.

The wobble effect can arise from a variety of factors. One factor is the unevenness of the outer edges 54a, 54b that may occur during their manufacture. Another is the effect of stacking together on a fixture multiple bellows components 54. Variations in the thickness of the chill rings 59 may also cause wobble.

According to the invention, the reference point determining device 63 determines at least one reference point RP relating to locations of the pairs of adjacent outer edges 54a, 54b of the bellows components 54. Specifically, according to the embodiment illustrated in FIG. 2, the reference point determining device uses the camera 57 aided by the illumination of the light source 61 and/or sensor 67 to “track” the seam S and/or a corresponding pair of adjacent outer edges 54a, 54b as the bellows components are rotated by the arbor 52a.

Although the tracking may be continuous, it is possible according to the present invention to register the position of the seam S and/or corresponding pair of adjacent outer edges 54a, 54b at discrete intervals as bellows components 54 are rotationally advanced on the fixture 52a. As shown in FIG. 5, for example, a continuous plot of the rotational advance of the seam S (shown by the solid line) may be estimated by taking a sample of points beginning with an initial point I and ending with a terminal point T, with three intervening intermediate points P1, P2, and P3. Based on the sample of points I, P1, P2, P3, and T an estimated plot C may be formed by linking each of the points with linear segments L1, L2, L3, L4. The laser beam 56 can be directed to trace between successive points as shown by the dashed line C made up of segments L1 to L4.

As illustrated in FIG. 6, a better approximation may be obtained by sampling at a greater number of discrete points, I, P1-P7, and T, leading, in turn, to shorter linear segments (shown by the dashed line) that approximate the plot of the rotationally advancing seam S (indicated by the solid line). Under certain circumstance, the high precision in welding achieved with continuous tracking may not warrant the additional cost and effort required, and sufficiently accurate welding according to the present invention may be achieved by sampling the position of the seam S and corresponding adjacent outer edges 54a, 54b at only discrete intervals. In general, the amount of sampling required is a function of the degree of wobble and the exactness required to achieve acceptable welding results.

According to the present invention, the laser beam 56 can be made to follow a predetermined function between successive points. Specifically, the successive points can be based on reference points determined by the reference point determining device 63 or be one or more of the reference points themselves. The specific function can be, for example, a linear function, a logarithmic function, a polynomial function, a power function, an exponential function, or a function based on a moving average. The particular function can be preselected or based on a selected reference point or set of reference points. The reference points may be determined automatically by the reference point determining device 63 or, alternately, be determined manually determined by an operator of the apparatus 50.

Still further, reference points may be determined automatically by the reference point determining device 63, but using input supplied by an operator. In any event, the apparatus enables sufficient welding without the need for continuous tracking of a seam S or corresponding outer edges of bellows components 54.

Moreover, according to a particular embodiment for achieving sufficient welding using non-continuous tracking, the laser beam 56 can be made to follow a predetermined function between successive points where the function is determined by fitting a curve based on sampled tracking observations of a seam S and/or corresponding adjacent outer edges of bellows components 54. Specifically, according to the embodiment illustrated in FIGS. 1 and 2, data in the form of captured images or sensed signals corresponding to adjacent outer edges 54a, 54b of bellows components are provided to the processor 62 from the camera 57 and/or sensor 67. Based on the data, the reference point determining device 63 derives a set of reference points. The controller then controls the positioner 53 and fixture 52 to direct the laser beam 56 to follow the desired or selected function between successive points.

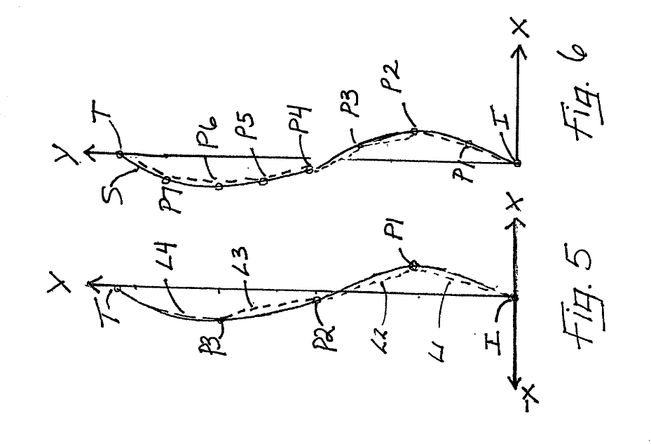

FIG. 7 shows a pair of dashed lines extending from respective initial points on respective seams, the dashed lines representing paths that approximate those of the seams and the path the laser beam will follow. FIG. 8 illustrates a linear path (dashed line) derived from fitting a straight line to an initial point and two successive reference points on a seam S. FIG. 9 illustrates a path based on linear segments from an initial point and three successive reference points on a seam S. FIG. 10 illustrates a path based on a greater number of reference points.

A specific example of an algorithmic-based technique for of fitting a curve that can be accommodated by the apparatus 50 is illustrated using three reference points I, P1, P2 taken from FIG. 6 to approximate the curvature of a corresponding portion of the curve shown in FIG. 6. The technique assumes the portion of S on which the reference points lie coincides with a segment of a circle. Based on the known geometric properties of the circle, the following calculations can be used to determine the curvature corresponding to S on the circle:

d=(½) (4R²−l²)^{½}=R cos(θ/2)=(½)l ctn(θ/2);

l=2(R²−d²)^{½}=2R sin(θ/2)=2d tan(θ/2);

h=R−d;

θ=S/R=2S/D=2 cos⁻¹(d/R)=2 tan⁻¹(l/2d) =2 sin⁻¹(l/D),

where R is the radius of the circle; D is the diameter; S is a segment of the circle between two points on the circle separated by angle θ; and l is the linear length of the arc relative to either the X or Y axis of the Cartesian plane.

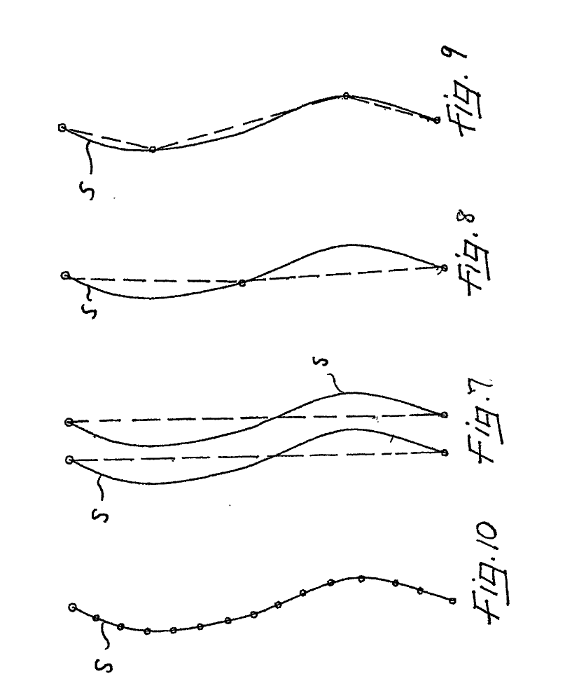

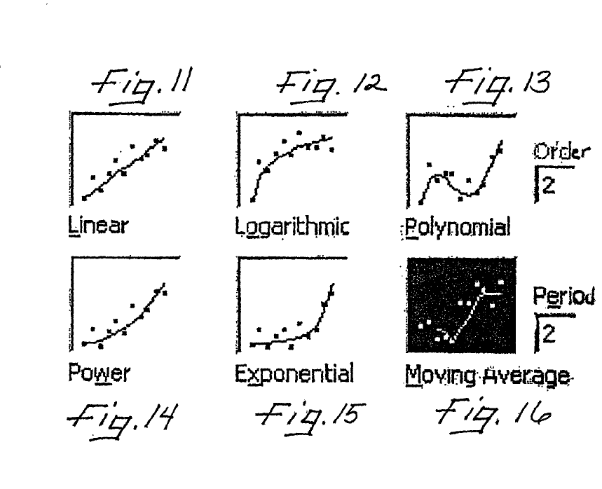

More generally, the function for the laser beam to follow may take on a variety of specific forms. As illustrated in FIG. 11, the function may correspond to a linear function. Alternately, as illustrated in FIG. 12, the function may correspond to a logarithmic function, or, as illustrated in FIG. 13, a second order polynomial function. Alternately, the function may correspond, for example, to a power function as illustrated in FIG. 14, or an exponential function as illustrated in FIG. 15. Still further the function can be based on a moving average as illustrated in FIG. 16. While these figures illustrate some of the possible functions, it will be clearly understood by one skilled in the art that many other functions may be fitted to any particular set of reference points.

It also will be understood that in a full rotation of the bellows components 54, different portions of the rotational advance of the seam S and/or corresponding outer edges may correspond to different functions based on curve fitting. Thus, for example, for the first quarter rotation, the function may be linear, whereas for the second quarter the function may be logarithmic, and for the last half exponential. According to one embodiment of the present invention, one role of the apparatus 50 can be to select that function that more closely fits the acquired data points so as to efficiently achieve a sufficient weld.

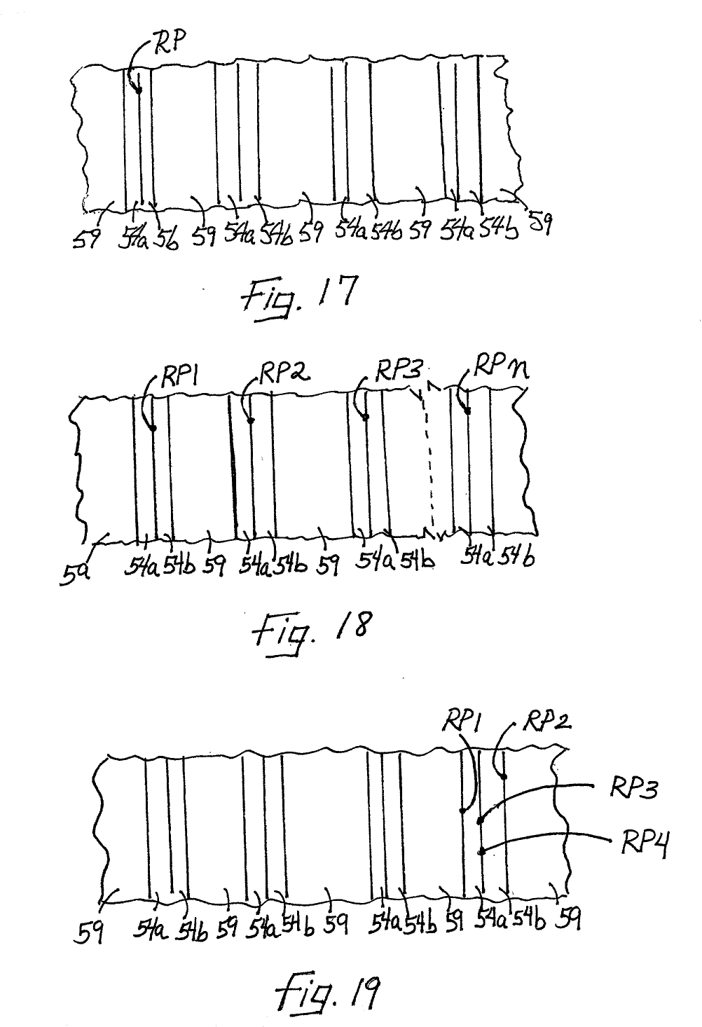

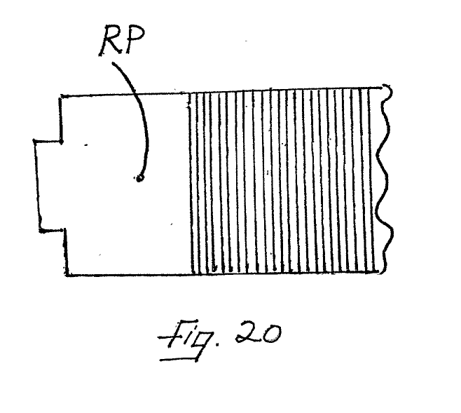

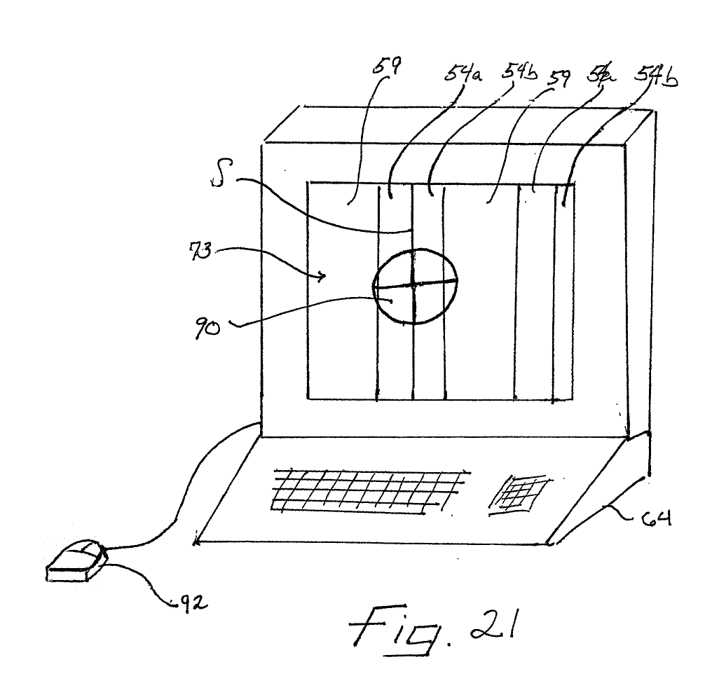

More generally, though, an at least one reference point can be used as a benchmark for positioning the laser beam 56 of the laser 55 relative to the pairs of adjacent outer edges 54a, 54b of the bellows components 54 to be welded together. As illustrated in FIG. 17, the at least one reference point RP may be a reference point on one of the pairs of adjacent outer edges 54a, 54b. Additionally, the at least reference point may be one of n respective reference points R1, R2, R3, Rn on each of the n pairs of adjacent outer edges as illustrated in FIG. 18. As further illustrated in FIG. 19, the at least one reference point also may be one of a plurality of reference points R1, R2, R3, R4 on one of the pairs of adjacent outer edges. Still further, the at least one reference point RP may be a reference point on the fixture as schematically shown in FIG. 20. For simplicity, the notched areas of the chill ring 59 next to adjacent outer edges 54a, 54b of the bellows components 54 are not shown in FIGS. 17-20.

The above-described operations are now described with reference to the specific embodiment of the apparatus 50 illustrated in FIG. 2. Initially, reference points on the pairs of adjacent outer edges 54a, 54b of bellows components 54 are determined from the signals generated by the camera 57 and/or sensor 67 as described above. These discrete points can be stored prior to actual welding or used concurrently with the welding. As also described above, the reference points provide a guide for where to direct the laser beam for efficient welding.

In terms of curve fitting, a curve that appears to match the data based on the signals generated by the camera 57 and/or sensor 67 can be selected automatically. Alternately, there also may be additional input from a user. Still further, reference point determination and/or curve fitting may be based solely on user input. Reference points as already described are positioned at discrete intervals as one advances around the circumference of the bellows components 54. The reference points, accordingly, are those that lie on or within a predetermined distance of the selected curve.

Although each of the functions of the apparatus 50 as already described can be performed automatically, the reference point determining device 63 as noted above is also able to operate on the basis of input provided by a human operator. Accordingly, the reference point determining device 63 may further include an optical system for presenting to the operator an image of at least one pair of adjacent edges of bellows components 54. The reference point determining device also may include as well as an input device for the operator to select and mark (e.g., electronically) the at least one reference point. Specifically, as perhaps best illustrated in FIG. 2, the optical system can include a second vision camera 68 that directly views a rotating pair of adjacent outer edges 54a, 54b of bellows components 54 mounted on the arbor 52a. The optical system camera 68 specifically can be an infrared camera.

More specifically, images are viewed through the schematically illustrated optics 70 and the image is processed by the illustrated vision processor 71 and shown on the illustrated display 73. As perhaps best illustrated in FIG. 21, the image conveyed by the vision camera 68 can be processed by a vision processor 71 and presented on the vision display 73 as a magnified image of the at least one pair of adjacent edges 54a, 54b of bellows components 54.

As also shown in FIG. 21, the apparatus 50 preferably includes a targeter 90 usable by the operator for selecting a location on adjacent outer edges 54a, 54b for marking a reference point. The targeter 90 specifically can be a crosshairs indicator that is movably superimposed on images of adjacent outer edges 54a, 54b displayed on the vision display 73. As will be well understood by one skilled in the art, the targeter 90 can be moved by the operator, for example, with the operator's using such conventional input devices as a keypad 64 and/or mouse 92.

After the operator positions the targeter 90, the operator marks the selected location of the reference point, preferably entering data with the keypad 64 or clicking with the mouse 92 as will be readily understood by one skilled in the art. The apparatus 50 can further provide a menu of options the operator can choose from in directing the determination of reference points and controlled welding of bellows components.

After, or contemporaneously with, the automatic or operator-dictated determination of at least one reference point, the controller directs the laser beam to weld together pairs of adjacent outer edges based upon the at least one reference point. As described above, one or more reference points can be selected so as to lie within a predetermined distance of one of hypothetical curves. These hypothetical curves include linear, logarithmic, polynomial, power, and exponential curves, as well as curves corresponding based on moving averages. Based on the reference points, the controller causes the laser beam to at least partially follow a predetermined function wherein the function is based on at least one of the hypothetical curves associated with the at least one reference point.

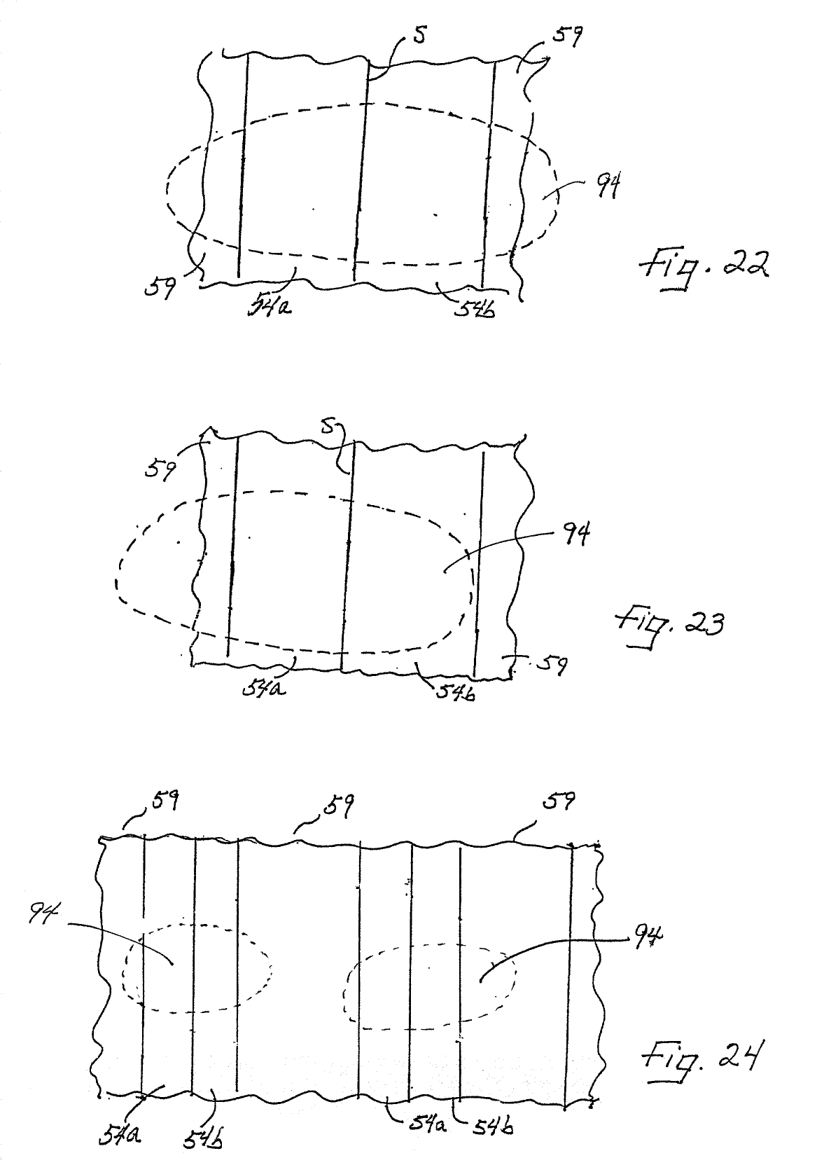

The laser 55, at each reference point and moving between successive reference points, can provide an enlarged beam coverage area so as to weld each pair of adjacent outer edges despite slight errors in relative position of the laser beam and pair of adjacent edges. As illustrated in FIGS. 22-23, the enlarged beam coverage area 94 may lie centered about the seam S between two adjacent outer edges 54a, 54b or it may lie off-center to the left or to the right. Nonetheless, the enlarged beam provides sufficient beam coverage area 94 to weld the adjacent edges. Moreover, as illustrated in FIG. 24, multiple pairs of adjacent outer edges 54a, 54b of bellows components 54 may be simultaneously welded by dividing the laser beam 56 or by using multiple lasers 55.

A method aspect of the invention is directed to welding adjacent outer edges 54a, 54b of bellows components 54 using laser welding and without the necessity of continuous seam tracking. The method includes supporting a plurality of bellows components on a fixture so that the components are in a side-by-side relation that defines at least one pair of adjacent outer edges 54a, 54b that are to be welded together. The method further includes determining at least one reference point relating to locations of the pairs of adjacent outer edges 54a, 54b of the bellows components 54. The method further includes directing a laser beam so that the laser beam welds together the pairs of adjacent outer edges 54a, 54b based upon the at least one reference point.

Further according to the present invention, the at least one reference point can include determining a reference point on at least one of said pairs of adjacent outer edges 54a, 54b. Determining at least one reference point can further include determining respective reference points on each of multiple pairs of adjacent outer edges 54a, 54b. Still further, determining at least one reference point can include determining a plurality of spaced-apart reference points for at least one of said pairs of adjacent outer edges 54a, 54b.

The method may further include directing the laser beam 56 to follow a predetermined function between successive points, wherein the predetermined function comprises at least one of a linear function, a logarithmic function, a polynomial function, a power function, an exponential function, and a function based on a moving average and determining an average reference point based upon the plurality of reference points. Further according to the method of the present invention, determining at least one reference point can include determining a reference point on the fixture 52 on which a plurality of bellows components 54 may be supported.

The method further includes directing a laser beam 56 to weld together the pairs of adjacent outer edges 54a, 54b based upon the at least one reference point after the determination of the at least one reference point has been made. The method of directing the laser beam 56 can further include directing a laser beam 56 having an enlarged beam coverage area sufficient to weld each pair of adjacent outer edges despite slight errors in relative positioning of the laser beam 56 and pair of adjacent outer edges 54a, 54b. Moreover, adjacent outer edges 54a, 54b of bellows components 54 may be simultaneously welded by dividing the laser beam 56 or by using multiple lasers 55.

The method further can include determining one reference point by viewing a magnified image of at least one pair of adjacent outer edges 54a, 54b, and may include using a camera 57 and display connected thereto to acquiring and viewing the magnified image. The image viewing, specifically, can be accomplished using an infrared camera. Further, the method can include determining at least one reference point using a sensor 67. The sensor-based determination can be accomplished, moreover, using a proximity sensor. Further, welding bellows components 54 can include welding at least one end plate and/or flange as well as bellows diaphragms. Welding, according to the present invention, can include using at least one of a Yb:YAG laser, an Nd:YAG laser, a carbon dioxide laser, and a diode laser to weld together bellows components 54.

Another method aspect of the present invention is directed to making bellows from bellows components 54 using at least one reference point based on input from an operator. The method includes supporting a plurality of bellows components 54 on a fixture 52 in side-by-side relation to define a plurality of pairs of adjacent outer edges 54a, 54b to be welded together. The method also includes presenting to an operator an image of the at least one pair of adjacent edges 54a, 54b, and accepting from the operator an input to set at least one reference point relating to locations of pairs of adjacent edges 54a, 54b of bellows components 54 supported on the fixture 52.

According to the method, moreover, input can be accepted from the operator so as to set a reference point on said fixture 52. The method can also include accepting an input to set a reference point on at least one of said pairs of adjacent outer edges, accepting an input to set a respective reference point on each of said pairs of adjacent outer edges, and accepting an input to set a plurality of spaced apart reference points for at least one of said pairs of adjacent edges.

The method can further include directing a laser beam 56 so that the laser beam 56 welds together the at least one pair of adjacent outer edges 54a, 54b of bellows components 54 based on the at least one reference point. The method can also include directing the laser beam to follow a predetermined function between successive points. More specifically, the method can include directing the laser beam to follow at least one of a linear function, a logarithmic function, a polynomial function, a power function, an exponential function, and a function based on a moving average. The method also includes determining an average reference point based upon the plurality of reference points.

According to the method, directing the laser beam 56 can be performed after accepting an input to set at least one reference point. Directing the laser beam 56, moreover, includes directing a laser beam 56 having an enlarged beam coverage area to weld each pair of adjacent outer edges despite slight errors in relative positioning of the laser beam and pair of adjacent outer edges. It also includes dividing a laser beam to simultaneously weld multiple pairs of adjacent outer edges, or using more than one laser to weld multiple pairs of outer edges.

Further according to the method, the presenting an image to the operator includes presenting a magnified image of the at least one pair of adjacent edges.

Many other modifications and other embodiments of the invention will come to the mind of one skilled in the art having the benefit of the teachings presented in the foregoing descriptions and the associated drawings. Therefore, it is to be understood that the invention is not to be limited to the specific embodiments disclosed, and that modifications and embodiments are intended to be included within the scope of the appended claims.

That which is claimed is:

1. An apparatus for making bellows from bellows components, the apparatus comprising:
a fixture for supporting a plurality of bellows components in side-by-side relation to define a plurality of pairs of adjacent outer edges to be welded together;
a reference point determining device for determining at least one reference point relating to locations of the pairs of adjacent outer edges of bellows components supported on said fixture;
a laser for generating a laser beam;
a positioner for relatively positioning the laser beam and said fixture; and
a controller for controlling said laser and said positioner so that the laser beam welds together the pairs of adjacent outer edges based upon the at least one reference point.

2. An apparatus according to claim 1 wherein the at least one reference point comprises a reference point on at least one of said pairs of adjacent outer edges.

3. An apparatus according to claim 1 wherein the at least one reference point comprises a respective reference point on each of said pairs of adjacent outer edges.

4. An apparatus according to claim 1 wherein the at least one reference point comprises a plurality of spaced apart reference points for at least one of said pairs of adjacent outer edges.

5. An apparatus according to claim 4 wherein said controller causes the laser beam to follow a predetermined function between successive points.

6. An apparatus according to claim 5 wherein the predetermined function comprises at least one of a linear function, a logarithmic function, a polynomial function, a power function, an exponential function, and a function based on a moving average.

7. An apparatus according to claim 4 wherein said controller determines an average reference point based upon the plurality of reference points.

8. An apparatus according to claim 1 wherein the at least one reference point comprises a reference point on said fixture.

9. An apparatus according to claim 1 wherein said controller controls said laser and said positioner to cause the laser beam generated by said laser to impinge on at least one welding point relating to locations of the pairs of adjacent outer edges of bellows components positioned on said fixture, and wherein the at least one welding point is within a predetermined distance of the at least one reference point.

10. An apparatus according to claim 1 wherein said laser provides an enlarged beam coverage area to weld each pair of adjacent outer edges despite slight errors in relative positioning of the laser beam and pair of adjacent outer edges.

11. An apparatus according to claim 1 wherein said laser provides a plurality of laser beams to simultaneously weld multiple pairs of adjacent outer edges.

12. An apparatus according to claim 1 wherein said reference point determining device comprises:
a optical system for presenting to an operator an image of at least one pair of adjacent edges; and
an input device for accepting from an operator an input to set the at least one reference point for use by said controller.

13. An apparatus according to claim 12 wherein said optical system presents a magnified image of the at least one pair of adjacent edges.

14. An apparatus according to claim 12 wherein said optical system comprises a camera and a display connected thereto.

15. An apparatus according to claim 12 wherein said camera comprises an infrared camera.

16. An apparatus according to claim 1 wherein said reference point determining device comprises a sensor connected to said controller.

17. An apparatus according to claim 1 wherein the bellows components comprise at least one end plate.

18. An apparatus according to claim 1 wherein the bellows components comprise a plurality of bellows diaphragms.

19. An apparatus according to claim 1 wherein said fixture comprises a rotatable arbor and a drive motor connected thereto.

20. An apparatus for making bellows from bellows components, the apparatus comprising:
a fixture for supporting a plurality of bellows components in side-by-side relation to define a plurality of pairs of adjacent outer edges to be welded together;
a laser for generating a laser beam;
a positioner for relatively positioning the laser beam and said fixture;
a optical system for presenting to an operator an image of at least one pair of adjacent edges;
an input device for accepting from the operator an input to set at least one reference point relating to locations of pairs of adjacent outer edges of bellows components supported on said fixture; and
a controller for controlling said laser and said positioner so that the laser beam welds together the pairs of adjacent outer edges based upon the at least one reference point.

21. An apparatus according to claim 20 wherein said optical system presents a magnified image of the at least one pair of adjacent edges.

22. An apparatus according to claim 20 wherein said optical system comprises a camera and a display connected thereto.

23. An apparatus according to claim 22 wherein said camera comprises an infrared camera.

24. An apparatus according to claim 20 wherein the at least one reference point comprises a reference point on at least one of said pairs of adjacent outer edges.

25. An apparatus according to claim 20 wherein the at least one reference point comprises a respective reference point on each of said pairs of adjacent outer edges.

26. An apparatus according to claim 20 wherein the at least one reference point comprises a plurality of reference points for at least one of said pairs of adjacent outer edges.

27. An apparatus according to claim 26 wherein said controller causes the laser beam to follow a predetermined function between successive points.

28. An apparatus according to claim 27 wherein the predetermined function comprises at least one of a linear function, a logarithmic function, a polynomial function, a power function, an exponential function, and a function based on a moving average.

29. An apparatus according to claim 26 wherein said controller determines an average reference point based upon the plurality of reference points.

30. An apparatus according to claim 20 wherein said laser provides an enlarged beam coverage area to weld each pair of adjacent outer edges despite slight errors in relative positioning of the laser beam and pair of adjacent outer edges.

31. An apparatus according to claim 20 wherein said laser provides a plurality of laser beams to simultaneously weld multiple pairs of adjacent outer edges.

32. An apparatus according to claim 20 wherein the bellows components comprise at least one end plate.

33. An apparatus according to claim 20 wherein the bellows components comprise a plurality of bellows diaphragms.

34. An apparatus according to claim 20 wherein said fixture comprises a rotatable arbor and a drive motor connected thereto.

35. A method of making bellows from bellows components, the method comprising:
supporting a plurality of bellows components on a fixture in a side-by-side relation to define a plurality of pairs of adjacent outer edges to be welded together;
determining at least one reference point relating to locations of the pairs of adjacent outer edges of the bellows components; and
directing a laser beam so that the laser beam welds together the pairs of adjacent outer edges based upon the at least one reference point.

36. A method according to claim 48 wherein accepting comprises accepting a reference point on at least one of said pairs of adjacent outer edges.

37. A method according to claim 48 wherein accepting comprises accepting a respective reference point on each of said pairs of adjacent outer edges.

38. A method according to claim 48 wherein accepting comprises accepting comprises a plurality of spaced apart reference points for at least one of said pairs of adjacent outer edges.

39. A method according to claim 38 wherein directing comprises directing the laser beam to follow a predetermined function between successive points.

40. A method according to claim 39 wherein directing comprises directing the laser beam to follow at least one of a linear function, a logarithmic function, a polynomial function, a power function, an exponential function, and a function based on a moving average.

41. A method according to claim 38 further comprising determining an average reference point based upon the plurality of reference points.

42. A method according to claim 48 wherein accepting comprises accepting a reference point on said fixture.

43. A method according to claim 48 wherein directing is performed after determining the at least one reference point.

44. A method according to claim 48 wherein directing comprises directing a laser beam having an enlarged beam coverage area to weld each pair of adjacent outer edges despite slight errors in relative positioning of the laser beam and pair of adjacent outer edges.

45. A method according to claim 48 wherein directing comprises directing a plurality of laser beams to simultaneously weld multiple pairs of adjacent outer edges.

46. A method according to claim 48 further comprising presenting an operator an image of at least one pair of adjacent edges and accepting from the operator an input to set the at least one reference point.

47. A method according to claim 46 wherein presenting comprises presenting a magnified image of the at least one pair of adjacent edges.

48. A method of making bellows from bellows components, the method comprising:
supporting a plurality of bellows components on a fixture in side-by-side relation to define a plurality of pairs of adjacent outer edges to be welded together;
presenting to an operator an image of the at least one pair of adjacent edges;
accepting from the operator an input to set at least one reference point relating to locations of pairs of adjacent edges of bellows components supported on said fixture; and
directing a laser beam so that the laser beam welds together the at least one pair of adjacent outer edges based on the at least one reference point.

49. A method according to claim 48 wherein accepting comprises accepting an input to set a reference point on at least one of said pairs of adjacent outer edges.

50. A method according to claim 48 wherein accepting comprises accepting an input to set a respective reference point on each of said pairs of adjacent outer edges.

51. A method according to claim 48 wherein accepting comprises accepting an input to set a plurality of spaced apart reference points for at least one of said pairs of adjacent edges.

52. A method according to claim 51 wherein directing comprises directing the laser beam to follow a predetermined function between successive points.

53. A method according to claim 52 wherein directing comprises directing the laser beam to follow at least one of a linear function, a logarithmic function, a polynomial function, a power function, an exponential function, and a function based on a moving average.

54. A method according to claim 51 further comprising determining an average reference point based upon the plurality of reference points.

55. A method according to claim 48 wherein accepting comprises accepting an input to set a reference point on said fixture.

56. A method according to claim 48 wherein directing is performed after accepting an input to set at least one reference point.

57. A method according to claim 48 wherein directing comprises directing a laser beam having an enlarged beam coverage area to weld each pair of adjacent outer edges despite slight errors in relative positioning of the laser beam and pair of adjacent outer edges.

58. A method according to claim 48 wherein directing comprises directing a plurality of laser beams to simultaneously weld multiple pairs of adjacent outer edges.

59. A method according to claim 46 wherein presenting comprises presenting a magnified image of the at least one pair of adjacent edges.
